(19) United States
(12) Patent Application Publication
(10) Pub. No.: US 2021/0076254 A1
(43) Pub. Date: Mar. 11, 2021

(54) HANDLING OF USER EQUIPMENT IDENTIFIERS OVER PC5 INTERFACE IN PC5-BASED USER EQUIPMENT TO NETWORK RELAY

(71) Applicant: Nokia Technologies Oy, Espoo (FI)

(72) Inventors: Vinh Van Phan, Oulu (FI); Dawid Koziol, Glogow (PL); Ling Yu, Kauniainen (FI)

(21) Appl. No.: 16/487,953

(22) PCT Filed: Mar. 1, 2018
(86) PCT No.: PCT/FI2018/050149

§ 371 Date: Aug. 22, 2019

Related U.S. Application Data
(60) Provisional application No. 62/475,585, filed on Mar. 23, 2017.

(51) Int. Cl. H04W 28/04; H04W 72/12; H04L 29/08

(52) U.S. Cl. CPC H04W 28/04; H04L 69/323; H04W 72/1278

(57) ABSTRACT

Various communication systems may benefit from efficient communication. For example, various wireless systems may benefit from appropriate handling of user equipment identifiers over a PC5 interface in a PCS-based user equipment to network relay. A method can include assigning to a user equipment an identifier. The identifier can be configured to avoid a layer one identifier collision between the user equipment and other nearby user equipment.

### CROSS REFERENCE TO RELATED APPLICATION:

This application is related to and claims the benefit and priority of U.S. Provisional Patent Application No. 62/475,585 filed on Mar. 23, 2017, the entirety of which is hereby incorporated herein by reference.

### BACKGROUND

### Field

Various communication systems may benefit from efficient communication. For example, various wireless systems may benefit from appropriate handling of user equipment identifiers over a PC5 interface in a PCS-based user equipment to network relay. PC5 refers to the radio interface specified in 3GPP LTE, release 12 and beyond, for direct device-to-device discovery and communication, also referred to as sidelink.

### Description of the Related Art

One aspect of 3GPP long term evolution (LTE) release 15 (Rel'15) is Further Enhancements to LTE Device to Device UE to Network Relays for Internet of Things (IoT) and Wearables, described at RP-161839, and referred to as feD2D.

An energy efficiency aspect is emphasized for the targeted use cases of feD2D: internet of things (IoT) and wearables. It is stated in RP-161839 that the sidelink air-interface may need to be optimized for energy efficient communication supporting various data rates, and that power efficiency may need to be addressed for evolved remote user equipment (UEs) which are meant for, for example, wearable devices.

In the current Rel'12-14 PC5 for proximity services (ProSe) device to device (D2D) communications, the layer two (L2) identifiers (IDs), including source (SRC) and destination (DST) and layer one (L1) IDs—8 bits of DST least significant bits (LSB)—of ProSe D2D UEs are not even known to serving evolved Node B (eNB). Thus, the eNB may not be able to coordinate and control L1 IDs to minimize the L1 ID collision, as the L2 IDs are assigned by a ProSe key management function, which resides in the core network and has a direct interface to the ProSe D2D UEs, as can be seen from TS 33.303.

FIG. 1 illustrates layer two identifiers in a medium access control (MAC) subheader. More particularly, FIG. 1 is based on TS 36.321 and shows how L2 IDs can be included in a MAC subheader for ProSe D2D communication over PC5 sidelink shared channel (SL-SCH).

### SUMMARY

According to a first embodiment, a method can include assigning to a user equipment an identifier, wherein the identifier is used to identify sender/receiver in sidelink.

In a variant, the identifier can be configured to avoid a layer one identifier collision between the user equipment and other nearby user equipment.

In a variant, the identifier can be a cell radio network temporary identifier.

In a variant the method can be performed by an access node serving the user equipment.

In a variant, the user equipment can be a remote user equipment or a relay user equipment.

In a variant, the method can further include providing a scheduling assignment resource for the user equipment, wherein the scheduling assignment resource can be configured to avoid the layer one identifier collision between the user equipment and other nearby user equipment.

In a variant, the providing the scheduling assignment resource can include grouping the user equipment into a scheduling assignment pool.

In a variant, a size of the pool can correspond to a maximum number of non-conflicting identifiers.

In a variant, the method can further include providing dedicated schedule assignment resources between a remote user equipment and an associated relay equipment, wherein the user equipment can be one of the remote user equipment or the associated relay user equipment.

In a variant, the dedicated schedule assignment resources can be provided based on received measurement reports.

In a variant, the identifier can be used as Source Layer-2 ID or Destination Layer-2 ID.

In a variant, the identifier can be included in an SL-SCH MAC subheader.

In a variant, a PHY Cell ID of the serving cell can also be included in SL-SCH MAC subheader.

In certain embodiments, some bits of the SL-SCH MAC subheader can be used to indicate whether relay and remote UEs are in a same cell or in different cells and the PHY Cell 1D can be of SRC or DST or both, or even if the remote UE is in an out-of-coverage state.

According to a second embodiment, an apparatus can include means for performing the method according to the first embodiment in any of its variants.

According to a third embodiment, an apparatus can include at least one processor and at least one memory including computer program code. The at least one memory and the computer program code can be configured to, with the at least one processor, cause the apparatus at least to perform the method according to the first embodiment in any of its variants.

According to a fourth embodiment, a computer program product may encode instructions for performing a process. The process can include the method according to the first embodiment, in any of its variants.

According to a fifth embodiment, a non-transitory computer readable medium may encode instructions that, when executed in hardware, perform a process. The process can include the method according to the first embodiment, in any of its variants.

### BRIEF DESCRIPTION OF THE DRAWINGS

For proper understanding of the invention, reference should be made to the accompanying drawings, wherein:

FIG. 1 illustrates layer two identifiers in a medium access control subheader.

FIG. 2 illustrates a sidelink shared channel medium access control subheader, according to certain embodiments.

FIG. 3 illustrates a method according to certain embodiments.

FIG. 4 illustrates a system according to certain embodiments.

### DETAILED DESCRIPTION

The current PC5 interface is based on the principle of transmitter-oriented one-to-many broadcast without L1 feedback control. The receiver in this principle monitors and receives all relevant packets and then filters out those packets that are actually intended for the receiver to receive and use. The rest of the packets are considered unintended packets and are discarded. This principle, in general, is not energy efficient for the receiver.

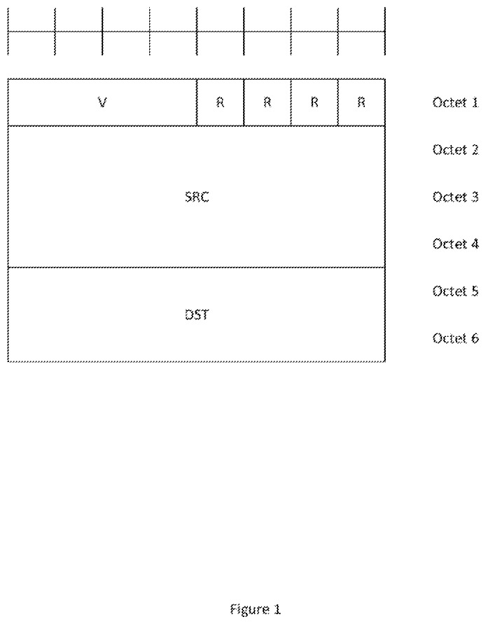

The following UE identifiers or identities can be used for the current sidelink over PC5: source layer-2 ID (SRC) and destination layer-2 ID (DST). SRC identifies the sender of the data in sidelink. SRC is 24 bits long and set to ProSe UE ID of the sending UE. 24 bits SRC is included in the MAC header in PC5, as shown in FIG. 1.

DST identifies the receiver or the group of receivers of the data in sidelink. DST is 24 bits long and may be split into two bit strings. The first bit string is the 8 LSB bits of DST used as Sidelink Control Layer-1 ID sent in L1 sidelink control information, also referred to as scheduling assignment (SA) from the sender in PC5. This partly identifies the receiver of the intended data in SA and is used for filtering out relevant SA at the physical layer (also referred to as L1 or PHY) of the receiver in PC5 to receive the intended data.

The second bit string is the 16 MSB bits of DST carried in the MAC header in PC5, as shown in FIG. 1. This can be used for filtering of intended packets at the MAC layer of PC5.

The eight-bit control Layer-1 ID described above can be referred to as L1 ID for short. Having L1 ID sent in SA can help the receiver filter out, to some extent, unintended SA and therefore avoid all radio reception of unintended data. Collisions in L1 ID are possible. That is, two or more different receivers in proximity of a transmitter may have the same L1 ID (8 LSB bits of DST or UE ID). Therefore, all of those receivers may carry out radio reception of data addressed to the same L1 ID by SA but actually intended for just one of them. This means that the rest of those receivers have wasted energy in receiving the unintended data. The probability of this problem's occurrence may be increased due to the fact that Layer-2 IDs are assigned in higher layers in the Core Network (CN) and delivered to UEs' Access Stratum (AS) with no control from a radio access network (RAN).

Certain embodiments, considering support of UE to network (UE2NW) relays for low energy IoT and wearables over PC5 based sidelink, can provide a method to significantly reduce L1 ID collision probability and the impact thereof for low energy IoT and wearables acting as remote UE devices. The method of certain embodiments can be based on handling of L2 IDs and L1 IDs of relay and remote UEs and resource pools used for sending SA by relay and remote UEs while keeping a similar structure to the current PC5. Thus, certain embodiments may allow for reusing PC5 to provide energy-efficient UE2NW relay for cellular access of low energy IoT and wearable devices.

Rel'12-14 ProSe D2D communications are for public safety use. Hence, 24 bits or 3 octets of SRC and DST are sufficient to address unique network-wise UE ID or Group ID. Rel'15 feD2D is aimed for both public safety and commercial uses. Thus, 3 octets may not be sufficient and if using unique network-wise UE ID of commercial UEs such as temporary mobile subscriber identity (TMSI) or international mobile subscriber identity (IMSI), SRC and DTS may need from 4 octets to 8 octets to implement, resulting in higher protocol overhead.

Certain embodiments provide a method to handle L2 IDs and L1 IDs of relay and remote UEs in PC5 based UE2NW relays for providing cellular access for low-energy IoT or wearable remote UE.

In certain embodiments, both remote UE and associated relay UE are in radio resource control (RRC) connected state during active relaying operation and have 16 bits cell-specific radio network temporary identifiers (C-RNTIs) assigned uniquely within the serving cell. Thus, in certain embodiments C-RNTIs are used as L2 IDs of the relay and remote UEs, for example as SRC and DST in SL-SCH MAC subheader for feD2D UE2NW relays.

Then, as there may be value in identifying relay and remote UEs uniquely among neighboring cells in multi-cell scenarios, certain embodiments also include PHY Cell ID of the serving cell in SL-SCH MAC subheader. This may be implemented with, for example, 10 bits out of a 2 octets field for octet-alignment, as there are less than 700 different values of PHY Cell ID in LTE RAN.

The serving cell may be common to both the relay and remote UEs. However, it may be possible that the relay and remote UEs are in coverage of different cells and even served by different cells. Hence, some bits of the leftover 6 spare bits may be used to indicate whether the relay and remote UEs are in coverage of the same cell or different cells and the PHY Cell 1D is of SRC or DST or both or even if the remote UE is in an out-of-coverage state. Providing such an indication of whether the relay and remote UEs are in different cells may enhance awareness of mobile contexts of the remote and associated relay UEs. In some embodiments, the relay UE may be configured to indicate to the serving eNB of the cell coverage status of the remote UE during active relaying operation based on the indication bits sent in MAC subheader over sidelink from the remote UE. The triggers for this indication from the relay UE may be, for examples, upon detecting a change in coverage status of the remote UE, for example from the same cell to different cell or vice versa as that of the relay UE or from in-coverage to out-of-coverage or vice versa. or otherwise periodic. The serving eNB, based on the indication from the relay UE on coverage status of the remote UE, may determine and configure optimal radio measurement and reporting for the remote UE.

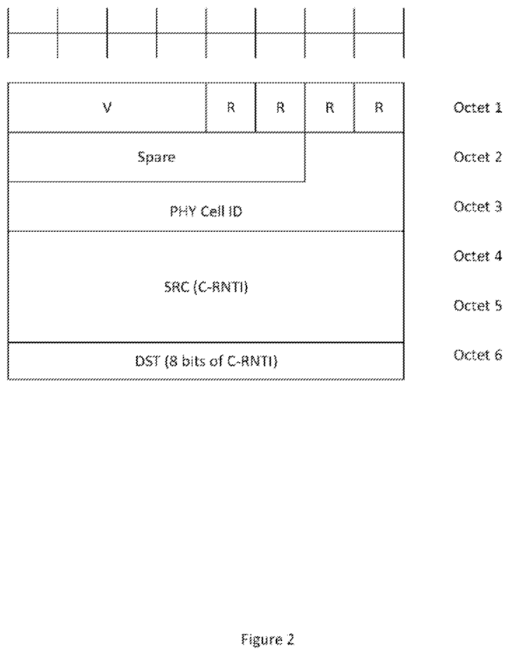

FIG. 2 illustrates a sidelink shared channel medium access control subheader, according to certain embodiments. As shown in FIG. 2, a new version value, V field, can be assigned for this new SL-SCH MAC subheader type of feD2D, as shown in FIG. 2. This field can have the same length as that shown in FIG. 1, for Rel'12-14 ProSe D2D communications. By utilizing 4 “R” bits, the first 2 octets may be sufficient to carry a PHY Cell ID field. This may save 1 octet of overhead. Thus, FIG. 2 shows a SL-SCH MAC subheader for feD2D with, for example, V=“0100” (the value of V is not shown in FIG. 2).

In certain embodiments, C-RNTI of the remote UE can be assigned, and reassigned if needed, by the serving eNB in such a way that L1 ID collision is avoided as much as possible within proximity of both the remote UE and the relay UE. L1 ID can be 8 LSB bits of C-RNTI of the remote UE, or any 8 bits of C-RNTI of the remote UE. The remaining 8 bits of C-RNTI of the remote UE can be included in SL-SCH MAC subheader, as configured by the serving eNB to both the remote UE and the relay UE. It may not be a problem for the serving eNB to assign such C-RNTI for remote UEs associated to the same relay UE as 8 bits of L1 ID can address up to 256 different UEs. However, there may be many relay UEs in the same cell or in neighboring cells, and each may serve a number of IoT or wearable remote UEs. Moreover, a remote UE may be in proximity of one or more relay UEs other than the associated relay UE as well as remote UEs being served by the other relay UEs. Even if the eNB had extensive proximity knowledge of remote UEs and relay UEs, 8 bits L1 ID providing an addressing space of 256 different values might be insufficient to avoid L1 ID collision in general. Thus, certain embodiments may have further enhancements that may work together with the C-RNTI assignment proposed in this embodiment.

For example, in certain embodiments the serving eNB may avoid or resolve L1 ID collisions for remote UEs via allocation of resources to be used for transmission of scheduling assignment (SA) for relay and remote UEs. This may include the following options.

For example, there can be one or more SA pools configured depending on load and/or spatial load distribution of feD2D traffic over a cell area. The serving eNB may then determine to distribute and allocate individual relay and remote UEs into individual pools so that L1 ID collision is avoided for remote UEs within individual pools. For instance, the serving eNB may configure a group of up to 256 remote UEs to monitor the same SA resource pool regardless of whether they are connected to the same or different relay UEs. For the group of up to 256 remote UEs, the serving eNB may allocate the C-RNTI in such a way that L1 IDs or the least 8 significant C-RNTI bits of the remote UEs are unique (not overlapping/conflicting) over the corresponding SA resource pool. Thus, the remote UE can monitor one SA resource pool and no conflict of L1 ID may happen in the same SA resource pool.

Another option can be to have dedicated SA resources between a remote UE and an associated relay UE, as configured by the serving eNB. The eNB may perform this resource allocation based on the eNB's configuration or based on additional input like measurement reports from configured UEs selected among relay and remote UEs in the cell. The measurement reports may be reports about, for example channel busy ratio (CBR) on targeted resource pool(s) and/or number of relay UEs discovered in proximity of reporting UEs and/or detected/reported L1 ID collisions.

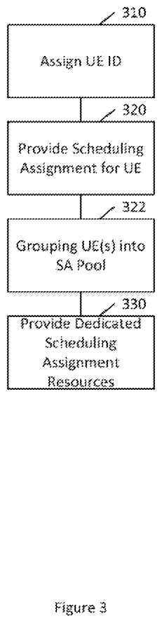

FIG. 3 illustrates a method according to certain embodiments. As shown in FIG. 3, a method can include, at 310, assigning to a user equipment an identifier. The identifier can be used to identify sender/receiver in sidelink. The identifier can be configured to avoid a layer one identifier collision between the user equipment and other nearby user equipment. The identifier can be a cell radio network temporary identifier. The method can be performed by an access node serving the user equipment. The user equipment can be a remote user equipment or a relay user equipment.

In a variant, the method can further include, at 320, providing a scheduling assignment resource for the user equipment. The scheduling assignment resource can be configured to avoid the layer one identifier collision between the user equipment and other nearby user equipment.

The providing the scheduling assignment resource can include, at 322, grouping the user equipment into a scheduling assignment pool. The size of the pool can correspond to a maximum number of non-conflicting identifiers. For example, if up to 256 identifiers can be provided without conflict, the maximum pool size may be set to 256, as in the example above.

The method can further include, at 330, providing dedicated schedule assignment resources between a remote user equipment and an associated relay equipment. The user equipment can be one of the remote user equipment or the associated relay user equipment. The dedicated schedule assignment resources can be provided based on received measurement reports, such as CBR and so on, as mentioned above.

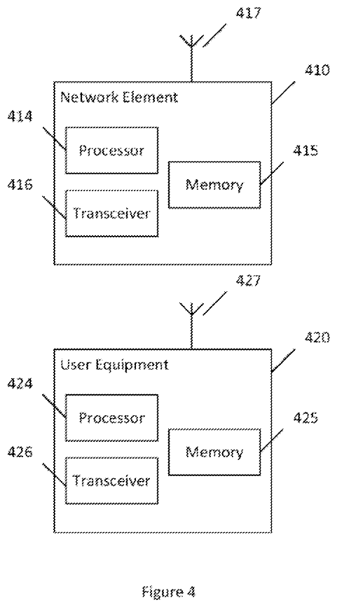

FIG. 4 illustrates a system according to certain embodiments of the invention. It should be understood that each block of the flowchart of FIG. 3 may be implemented by various means or their combinations, such as hardware, software, firmware, one or more processors and/or circuitry. In one embodiment, a system may include several devices, such as, for example, network element 410 and user equipment (UE) or user device 420. The system may include more than one UE 420 and more than one network element 410, although only one of each is shown for the purposes of illustration. A network element can be an access point, a base station, an eNode B (eNB), next generation Node B (gNB), or any other network element, such as a PCell base station or a PSCell base station. Each of these devices may include at least one processor or control unit or module, respectively indicated as 414 and 424. At least one memory may be provided in each device, and indicated as 415 and 425, respectively. The memory may include computer program instructions or computer code contained therein, for example for carrying out the embodiments described above. One or more transceiver 416 and 426 may be provided, and each device may also include an antenna, respectively illustrated as 417 and 427. Although only one antenna each is shown, many antennas and multiple antenna elements may be provided to each of the devices. Other configurations of these devices, for example, may be provided. For example, network element 410 and UE 420 may be additionally configured for wired communication, in addition to wireless communication, and in such a case antennas 417 and 427 may illustrate any form of communication hardware, without being limited to merely an antenna.

Transceivers 416 and 426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 420 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof The user device or user equipment 420 may be a sensor or smart meter, or other device that may usually be configured for a single location.

In an exemplifying embodiment, an apparatus, such as a node or user device, may include means for carrying out embodiments described above in relation to FIG. 3.

Processors 414 and 424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 415 and 425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 410 and/or UE 420, to perform any of the processes described above (see, for example, FIG. 3). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 4 illustrates a system including a network element 410 and a UE 420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may allow a radio access network to minimize the probability of L1 ID collision and thus minimize unnecessary packet reception and layer 2 processing in a D2D UE. A further consequence may be a significant decrease in power consumption of UEs, both remote and relay UEs. As remote UE's power consumption may be of higher concern, relay UEs may take over the aforementioned radio measurement and reporting including, for example, CBR and proximity discovery as much as possible. The serving eNB may assign or reassign C-RNTI for a remote UE based on serving contexts of the associated relay UE including contexts of other remote UEs the associated relay UE is serving and serving contexts of other relay UEs in proximity of the associated relay UE.

The serving eNB may also control reporting of L1 collision for remote UE. For examples, a remote UE may report L1 collision if that happens frequently or repeatedly enough. Then, upon receiving the report of L1 collision, the serving eNB may reassign C-RNTI for the reporting remote UE or reconfigure the remote UE and the associated relay UE on SA resources to be used so as to resolve L1 ID collision for the remote UE. In some cases, the serving eNB may determine to reconfigure the reported remote UE instead of the reporting remote UE. In multi-cell scenarios, neighboring cells may also coordinate to resolve possible L1 collision for remote UEs.

As noted above, the existing 24 bits Layer-2 IDs as network-wise UE IDs of public safety users may be insufficient for addressing commercial users. However, if such network-wise Layer-2 IDs are applied for feD2D, Layer-2 IDs of active feD2D UEs may be indicated to the serving eNB, either by feD2D UEs or CN. The serving eNB may then coordinate L1 ID assignment so that collisions are avoided. Alternatively, if higher layer network functions, such as ProSe key management function, will be able to ensure that Layer-2 IDs of the UEs are unique in the network or in the specific area, then it might not be necessary to inform these Layer-2 IDs to the eNB. Instead the eNB can assign a layer 1 ID to the remote and relay UEs independently from these Layer-2 IDs, in such a way that collisions are avoided as much as possible using the aforementioned techniques. In this case any remaining conflicts could be resolved by having full Layer-2 IDs as assigned by the higher layer function used as SRC and DST fields in SL-SCH MAC subheader.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

D2D Device to Device

SA Scheduling Assignment

1-17. (canceled)

18. An apparatus comprising:
at least one processor; and
at least one memory including computer program code,
wherein the at least one memory and the computer program code are configured to, with the at least one processor, cause the apparatus at least to:
assign to a user equipment an identifier, wherein the identifier is used to identify sender/receiver in sidelink, wherein the identifier is a cell radio network temporary identifier and the identifier is included in a medium access control subheader.

19. The apparatus of claim 18, wherein the identifier is configured to avoid a layer one identifier collision between the user equipment and other nearby user equipment.

20. The apparatus of claim 18, wherein the apparatus comprises an access node serving the user equipment.

21. The apparatus of claim 18, wherein the user equipment is a remote user equipment or a relay user equipment.

22. The apparatus of claim 18, wherein the at least one memory and the computer program code are further configured to, with the at least one processor, cause the apparatus to:
provide a scheduling assignment resource for the user equipment, wherein the scheduling assignment resource is configured to avoid the layer one identifier collision between the user equipment and other nearby user equipment.

23. The apparatus of claim 22, wherein the providing the scheduling assignment resource comprises grouping the user equipment into a scheduling assignment pool.

24. The apparatus of claim 23, wherein a size of the pool corresponds to a maximum number of non-conflicting identifiers.

25. The apparatus of claim 18, wherein the at least one memory and the computer program code are further configured to, with the at least one processor, cause the apparatus to:
provide dedicated schedule assignment resources between a remote user equipment and an associated relay equipment, wherein the user equipment is one of the remote user equipment or the associated relay user equipment.

26. The apparatus of claim 25, wherein the dedicated schedule assignment resources are provided based on received measurement reports.

27. The apparatus of claim 18, wherein the identifier is used as Source Layer-2 identifier or Destination Layer-2 identifier.

28. The apparatus of claim 18, wherein the identifier is included in a sidelink shared channel medium access control subheader.

29. The apparatus of claim 28, wherein a physical layer cell identifier of the serving cell is also included in the sidelink shared channel medium access control subheader.

30. The apparatus of claim 29, wherein some bits of the sidelink shared channel medium access control subheader are used to indicate whether a remote user equipment and an associated relay user equipment are in a same cell or in different cells and the physical layer cell identifier is of source or destination or both, or if the remote user equipment is in an out-of-coverage state.

31. A method, comprising:
assigning to a user equipment an identifier, wherein the identifier is used to identify sender/receiver in sidelink, wherein the identifier is a cell radio network temporary identifier and the identifier is included in a medium access control subheader.

32. The method of claim 31, wherein the identifier is included in a sidelink shared channel medium access control subheader.

33. The method of claim 32, wherein a physical layer cell identifier of the serving cell is also included in the sidelink shared channel medium access control subheader.

34. The method of claim 33, wherein some bits of the sidelink shared channel medium access control subheader are used to indicate whether a remote user equipment and an associated relay user equipment are in a same cell or in different cells and the physical layer cell identifier is of source or destination or both, or if the remote user equipment is in an out-of-coverage state.

35. An apparatus comprising:
at least one processor; and
at least one memory including computer program code,
wherein the at least one memory and the computer program code are configured to, with the at least one processor, cause the apparatus at least to:
receive by a user equipment, an identifier, wherein the identifier is used to identify sender/receiver in sidelink, wherein the identifier is a cell radio network temporary identifier and the identifier is included in a medium access control subheader.

36. The apparatus of claim 35, wherein the identifier is configured to avoid a layer one identifier collision between the user equipment and other nearby user equipment.

37. The apparatus of claim 35, wherein the user equipment is a remote user equipment or a relay user equipment.
